(19) United States
(12) Patent Application Publication
(10) Pub. No.: US 2007/0051669 A1
(43) Pub. Date: Mar. 8, 2007

(54) Screening machine with removable feed hopper

(76) Inventors: Timothy M. Mandrell, Rock Falls, IL (US); Louis DeMay, Rock Falls, IL (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/364,727

(22) Filed: Feb. 28, 2006

Related U.S. Application Data
(60) Provisional application No. 60/657,346, filed on Mar. 1, 2005.

(51) Int. Cl. B07B 1/00

(52) U.S. Cl. 209/240

(57) ABSTRACT

The invention relates to an apparatus for screening particulate material comprising an elongated frame comprising a first end and a second end and a feed hopper reversibly attached to the first end of the elongated frame such that the feed hopper can be coupled and uncoupled from the elongated frame. Removing the feed hopper allows the screening machine user to feed the screening machine from three sides of the screening machine. In addition, the screening machine can be fed from a conveying device, from earthmoving equipment, or from some other device. Further, removing the feed hopper lowers the receiving height of the screening machine, allowing easier access for loading particulate material onto the screening machine.

### CROSS-REFERENCE TO RELATED APPLICATIONS

The current applications claims the benefit of priority from U.S. provisional patent application filed on Mar. 1, 2005, entitled “Screening Machine With Removable Feed Hopper,” having Ser. No. 60/657,346, which is incorporated herein by reference.

### FIELD OF INVENTION

The invention relates generally to machines used for screening and separating particulate material. In particular, the invention relates to a machine used for separating particulate material of various sizes into separate piles of like-sized material, wherein the feed hopper on the machine is removable.

### BACKGROUND OF THE INVENTION

Machines for separating particulate material are known in the art. Oftentimes it is desired to separate materials of different sizes into separate piles, for further processing or disposal. For example, sand or soil and dirt may contain rocks, concrete, asphalt, roots, stumps and other debris. Smaller-dimensioned material, such as sand or soil, can be separated from larger materials by pouring the mixture into a vibrating screen apparatus. The mesh of the screen is sized to allow the smaller-dimensioned material to fall through the screen, and the larger-dimensioned material is retained above the screen. The screening process can be repeated for the smaller-dimensioned material, for the larger-dimensioned material, or both, thus further separating the materials.

The particulate material that falls through the screen can be collected in a container or, alternatively, the material can drop onto a conveyor and be transported to a container or discharged from the conveyor and onto a pile on the ground. Optionally, the material that falls through the first screen can be caught on a second screen and screened again, thus further separating the particulate material. The material remaining on the first screen can be dropped onto a conveyor and transported to a container or discharged onto a pile on the ground.

The material to be screened is typically loaded into a hopper that is mounted to the frame of the screening machine, on which the various conveyors are also mounted. Oftentimes, the hopper is positioned above a conveyor, such that material from the hopper falls to the conveyor below, and the conveyor transports the material to the screens. The hopper is often filled from the top by loaders that pour the particulate material into the hopper. It is advantageous to be able to load the hopper from more than one side of the hopper, thus providing more flexibility to hopper and screening machine placement, and allowing for filling by multiple loaders.

Some of the screening machines are designed to be portable, such that the machine can be moved from worksite to worksite, or to various locations on one worksite. The screening machine may have wheels attached such that it can be towed behind another vehicle. Alternatively, the screening machine can be towed onto a trailer and hauled by trailer to another location. Yet another alternative is for the screening machine to include an endless track apparatus, such that the screening machine can be moved without having to be towed or hauled by another vehicle.

U.S. Pat. No. 5,234,564 to Smith entitled “Mobile Screen Assembly for Rubble and Debris” appears to disclose a screening machine with a plurality of conveyors that transport particulate material from the hopper to a number of screens and then into separate piles, based upon size of the particulate material. The hopper is supported on” the machine frame and is disposed over a lower inclined portion of the upwardly inclined transport conveyor. The screening machine can be towed by a vehicle over the road or highway.

U.S. Pat. No. 6,698,594 to Cohen et al. entitled “Screening Machine” appears to disclose a mobile screening machine on endless tracks. A hopper and a main conveyor are mounted to the screening machine frame. A screening device, which is positioned beneath the upper end of the main conveyor and extends further longitudinally along the frame, screens the particulate material into three grades of coarseness. The tracks allow the screening machine to be driven around a work site or driven onto a trailer.

Although the two screening machines noted above, and other such screening machines, may be able to screen particulate material, the machines have certain disadvantages that will be noted below. There exists a need for a screening machine that overcomes the disadvantages of the prior art.

### SUMMARY OF THE INVENTION

Although there exist a number of different types of screening machines, there is a need for a screening machine with a removable feed hopper. Removing the feed hopper allows the screening machine user to feed the screening machine from three sides of the screening machine. In addition, the screening machine can be fed from a conveying device, from earthmoving equipment, or from some other device. Further, removing the feed hopper lowers the receiving height of the screening machine, allowing easier access for loading particulate material onto the screening machine. A removable feed hopper provides versatility and flexibility to the use of the screening machine.

In a first aspect, the invention relates to an apparatus for screening particulate material comprising an elongated frame comprising a first end and a second end and a feed hopper attached to the first end of the elongated frame comprising a plurality of wall members operably connected to define an interior space adapted to receive particulate matter poured into a top of the feed hopper, a first stationary engagement element and a first pivotal engagement element, wherein the first stationary engagement element and the first pivotal engagement element can couple with corresponding engagement elements on the first end of the elongated frame to reversibly attach the feed hopper to the first end of the elongated frame. In these embodiments, the apparatus can further comprise a screen assembly operably coupled to the second end of the elongated frame comprising a first screen deck including a mesh portion having openings adapted to separate particulate material fed into the feed hopper, and a conveyor operably coupled to the elongated frame and extending longitudinally along the elongated frame to convey particulate material from the feed hopper to the screen assembly.

In a second aspect, the invention relates to an apparatus for screening particulate material comprising an elongated frame comprising a first end and a second end and a feed hopper attached to the first end of the elongated frame comprising a plurality of wall members operably connected to define an interior space adapted to receive particulate matter poured into a top of the feed hopper and at least one engagement element that is adapted to couple with a corresponding element on the elongated frame to reversibly attach the feed hopper to the elongated frame. The apparatus can further comprise a screen assembly operably coupled to the second end of the elongated frame comprising at least one screen deck having a mesh portion having openings adapted to separate particulate material fed into the feed hopper, and a conveyor operably coupled to the elongated frame and extending longitudinally along the elongated frame to convey particulate material from the feed hopper to the screen assembly.

In another aspect, the invention relates to a method of operating an apparatus for screening particulate material comprising reversibly attaching a feed hopper to a first end of an elongated frame of a screening apparatus, wherein the screening apparatus comprises a screen assembly operably coupled to a second end of the elongated frame comprising at least one screen deck having a mesh portion adapted to separate particulate material fed into the feed hopper, and a conveyor operably coupled to the elongated frame and extending longitudinally along the elongated frame to convey particulate material from the feed hopper to the screen assembly.

### BRIEF DESCRIPTION OF THE DRAWINGS

FIG. 1 is a side perspective view of the screening machine with the feed hopper attached to the machine.

FIG. 2 is a perspective view of the screening machine with the fold-over receiving hopper attached.

FIG. 3 is a perspective view of the feed hopper and the screening machine, with the hooks of the feed hopper attached to the screening machine.

FIG. 4 is a perspective view of the feed hopper and the screening machine, with the hooks of the feed hopper disengaged.

FIG. 5 is a side elevational view of the feed hopper disengaged from the screening machine.

FIG. 6 is a perspective view of the feed hopper and the screening machine, with the feed hopper disengaged from the screening machine.

FIG. 7 is a perspective view of the screening machine without the feed hopper and with the fold-over receiving hopper in storage position.

FIG. 8 is a side elevational view of the hopper end of the screening machine with the fold-over hopper in operational position.

FIG. 9 is a perspective view of the feed hopper and the screening machine.

FIG. 10 is a view of the hydraulic hoses located under the feed hopper.

### DETAILED DESCRIPTION

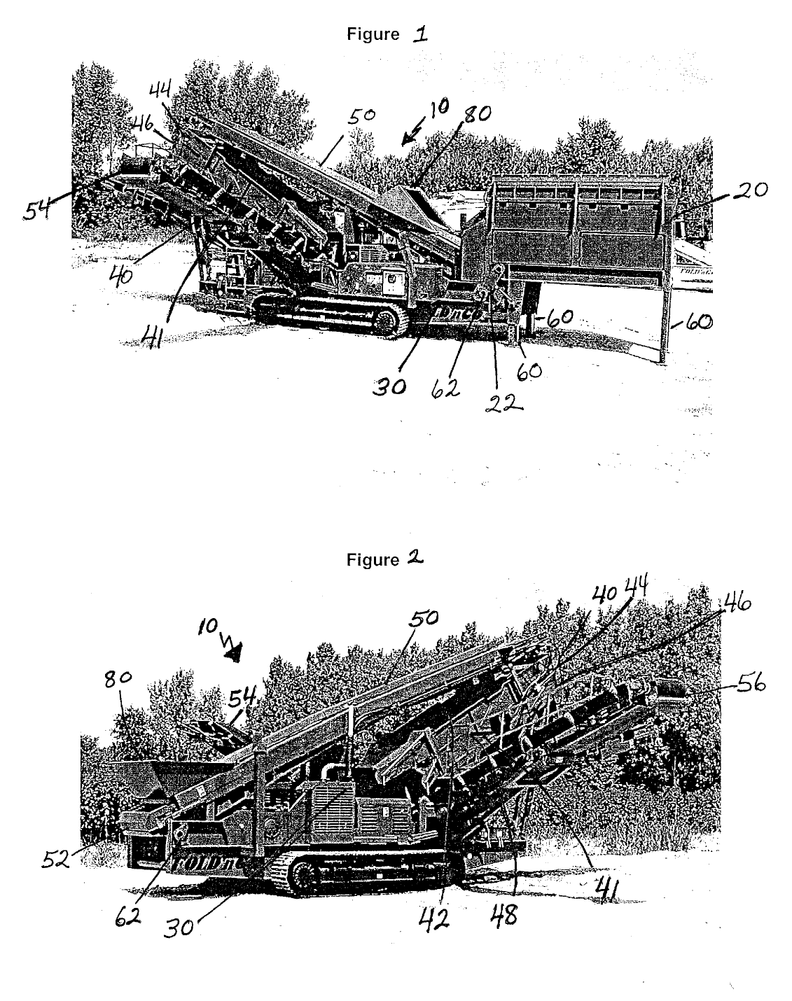

Referring to FIG. 1 and 2, a screening machine 10 is shown in operating configuration, with a feed hopper 20 attached to one end of the main frame 30 of the screening machine. The main frame 30 of the screening machine is elongate and rigid, with the various components of the screening machine 10 connected or attached to the main frame 30. The screen assembly 40 of the screening machine 10 is attached to the main frame 30 and located at the opposite end of the screening machine main frame 30 from the feed hopper 20. A belt-feeder 52 is positioned below the feed hopper 20 and conveys material to the main conveyor 50, which in turn conveys material to the screen assembly 40 of the screening machine 10. Material at the screen assembly 40 of the screening machine 10 is then separated into three piles of differently-sized particles.

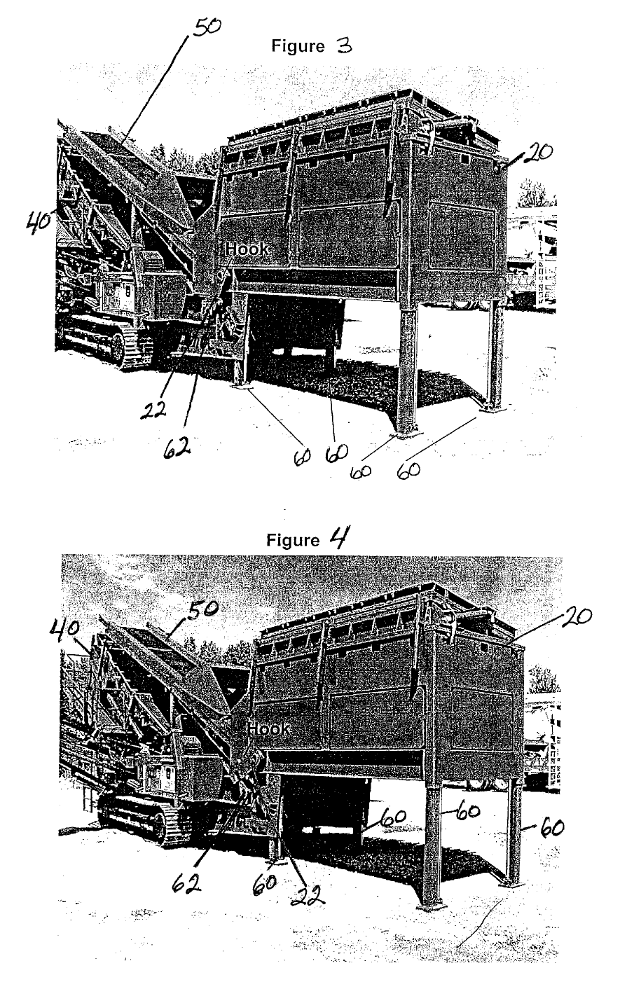

The feed hopper 20 is located at one end, the proximate end, of the screening machine 10, parallel to the main frame 30. Referring to FIGS. 3 and 4, further, the feed hopper 20 is attached to the main frame 30 with a series of hooks 22. In one embodiment of the invention, the feed hopper 20 is attached to the main frame 30 with four hooks 22. Two of the four hooks 22 are stationary and are fixed to the bottom of the feed hopper 20 (not shown). The remaining two hooks 22 are positioned proximate the middle of the feed hopper 20 and are free to pivot when required to do so. It is understood that the number of hooks 22 can be modified, dependent upon the needs of the equipment.

Mounted directly below the feed hopper 20 is a belt feeder 52, which is a variable speed conveyor. The belt feeder 52 is also positioned parallel to the screening machine main frame 30. The belt feeder 52 receives material that has been dumped into the feed hopper 20 and falls through the bottom of the feed hopper 20. The belt feeder 52 then conveys this material to the main conveyor 50.

The main conveyor 50 is positioned parallel to the screening machine main frame 30, with the lower end of the main conveyor 50 mounted to the main frame. The main conveyor 50 extends longitudinally uphill and terminates at the screen assembly 40. The upper end of the main conveyor 50 is mounted to the screen assembly 40 and pivots as the screen assembly 40 angle changes.

Referring again primarily to FIGS. 1 and 2, the screen assembly 40 comprises a two-deck screen configuration, with an upper screen deck 44 and a lower screen deck 46. Each screen deck 44, 46 includes a screen 42, 48 designed to separate the particulate material fed into the feed hopper 20. The two screens 42, 48 have a differently sized mesh as compared to one another, such that larger particulate material will be retained on the upper screen 42, while smaller particulate material will pass through screen 42 and onto the lower screen 48 below.

The screen assembly 40 is mounted parallel to the screening machine main frame 30 and is positioned downhill, angling down towards the feed hopper end of the screening machine 10. Hence, the screen assembly 40 is positioned parallel and beneath the main conveyor 50, inclined downhill, such that the particulate material on the screen assembly 40 travels back towards the feed hopper end of the screening machine 10.

Particulate material is discharged from the two-deck screen assembly 40 by way of two stockpiling conveyors 54, 56 positioned perpendicularly in relation to the screen assembly 40 and main conveyor 50. Referring primarily to FIGS. 1, 2 and 6, the two stockpiling conveyors 54, 56 are located proximate the feed hopper end of the screening machine 10. Material that is too large to pass through the upper screen deck 44 is discharged on the first stockpiling conveyor 54 and the material is piled on one side of the screening machine 10. Material that passes through the upper screen deck 44 falls to the lower screen deck 46. Material that fails to pass through the lower screen deck is discharged on the second stockpiling conveyor 56. The second stockpiling conveyor 56 is positioned on the opposite side of the screen assembly 40 in relation to the first stockpiling conveyor 54. Hence, the second stockpiling conveyor 56 discharges intermediate-sized particulate material on the opposite side of the screening machine 10 in relation to the first pile of particulate material discharged by the first stockpiling conveyor 54.

An underscreen conveyor 58 is positioned below the screen assembly 40 and is mounted directly to the screen assembly frame 41. Further, the underscreen conveyor 58 is mounted parallel to the screen frame 41. Material that passes through both screens 42, 48 of the screening assembly 40 drops onto the underscreen conveyor 58. The underscreen conveyor 58 discharges this smaller-sized particulate material at the back end of the screen assembly 40 end of the screening machine 10, distal the feed hopper end of the screening machine 10.

In use, particulate material is loaded into the feed hopper 20 by a loader or other type of earthmoving device. The feed hopper 20 is loaded through its top and material drops to the belt feeder 52, which transports the material to the main conveyor 50. The main conveyor 50 transports the material uphill and discharges the material onto the screen assembly 40. Material that remains on the upper screen deck 44 is discharged to the ground or into a container on one side of the screening machine 10 by way of a first stockpiling conveyor 54. Material that passes to the lower screen deck 46 is discharged to the ground or into a container on the opposite side of the screening machine 10 from the first discharged pile. The material from the lower screen deck 46 is discharged by a second stockpiling conveyor 56. The material that passes through both the upper and lower screen decks 42, 48 falls to the underscreen conveyor 58. The underscreen conveyor 58 discharges this particulate material out the screen end of the screening machine 10.

Referring primarily to FIGS. 1-4, the screening machine of the invention includes a removable feed hopper 20 and a fold-over hopper 80 that remains attached to the screening machine 10, even when the feed hopper 20 is attached and operating. Situations may arise where the screening machine 10 is to be used, but the height of the feed hopper 20 makes use of the screening machine 10 in its current configuration difficult or even impossible. Removing the feed hopper 20 lowers the receiving height of the screening machine 10 and allows the screening machine 10 to be fed from three sides. In particular, a lower receiving height is desired when feeding the screening machine 10 from another conveying device or from earthmoving equipment.

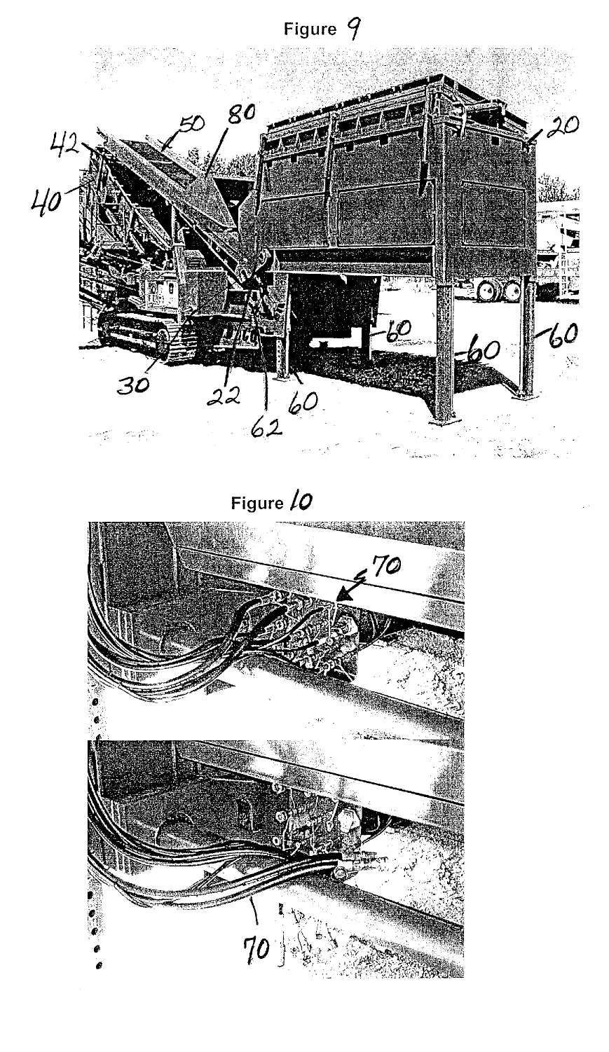

In one embodiment of the invention, the feed hopper 20 is attached to the screening machine main frame 30 with four hooks 22. Two of the hooks 22 are stationary and fixed to the bottom of the feed hopper 20. As best shown in FIGS. 3, 4, 6 and 9, the remaining two hooks 22 are located proximate the middle of the feed hopper 22 and are free to pivot when required to do so. Further, the feed hopper 20 sits on four hydraulic legs 60. The four hydraulic legs 60 are raised to their maximum height and pinned into position. As the hydraulic legs 60 are raised, the feed hopper hooks 22 are lifted off of securing tubes 62 that are mounted on the screening machine main frame 30. With the pivoting hooks 22 swiveled up and out of the way, no longer connected to the feed hopper 20, the feed hopper 20 can be detached from the screening machine main frame 30.

Referring to FIG. 10, the hydraulic hoses 70 that connect the feed hopper 20 to the screening machine main frame 30 are attached using quick-disconnect fittings. These fittings must be disconnected when removing the feed hopper 20 from the screening machine 10. Each of the fittings is either a different size or has a different end, so that the hydraulic hoses 70 may be hooked back up in only one configuration. The unique nature of each fitting simplifies the set-up process when re-attaching the feed hopper 20.

Once the feed hopper 20 is disengaged from the screening machine 10, the screening machine 10, for example, can be driven away from the feed hopper 20 and attached to another feed hopper. Alternatively, instead of attaching another feed hopper 20, a fold-over receiving hopper 80 already attached to the screening machine can be positioned over the main conveyor 50 and be ready for use. The feed hopper 20 can be attached to another screening machine, since the feed hopper 20 can be used on multiple units without modification. In addition, the disengaged feed hopper 20 can be used as a stand-alone unit, with the addition of a power unit. No external tools are required to disengage the feed hopper 20 from the screening machine 10.

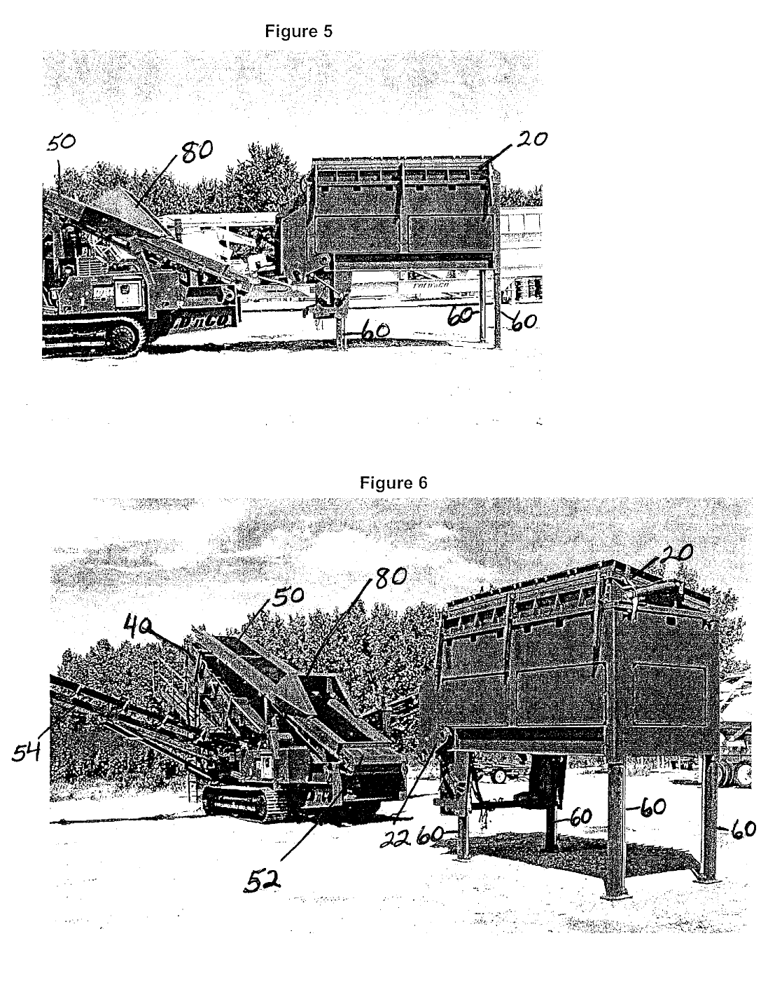

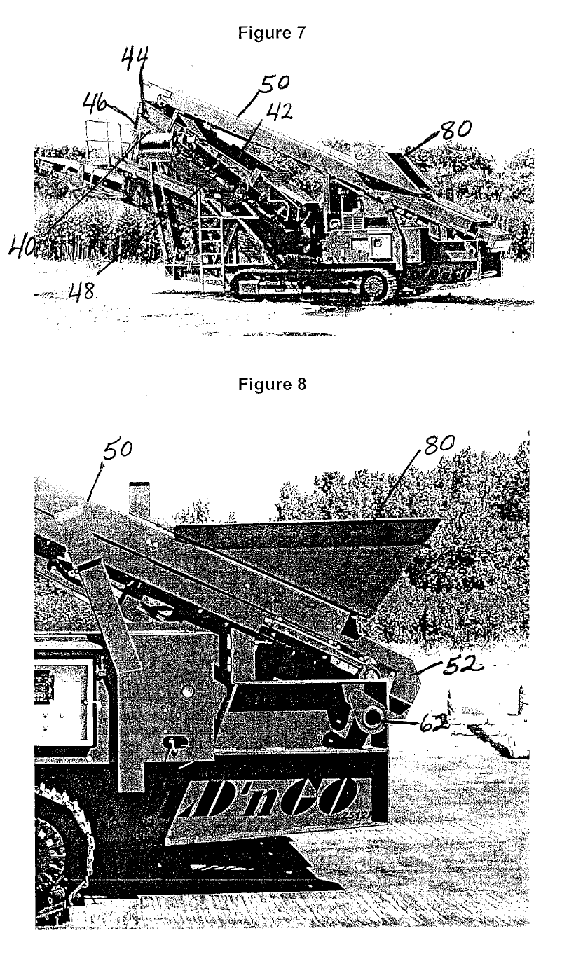

As noted above, once the feed hopper 20 is removed, it may be desirous to have another type of hopper attached to the screening machine 10, so that material can still be loaded for separation. A fold-over receiving hopper 80 can be used in place of the feed hopper 20. Referring to FIGS. 1-9, the fold-over hopper 80 can be attached to the screening machine 10 when the feed hopper 20 is also attached to the screening machine 10. However, the fold-over receiving hopper 80 is positioned out of the way of the operating screening machine 10 by being folded-over the main conveyor 50, for example. When the feed hopper 20 is removed, the fold-over receiving hopper 80 is placed into operating position. The fold-over receiving hopper 80 can be fed from three directions, thus making for easy loading of the screening machine 10.

The screening machine 10 of the invention is mobile and is mounted to a pair of endless tracks 90. The tracks 90 are powered by an on-machine engine, which when needed, will move the screening machine 10 in multiple directions. Further, movement of the tracks 90, and hence the screening machine 10, can be remotely controlled.

The embodiments above are intended to be illustrative and not limiting. Additional embodiments are within the claims. Although the present invention has been described with reference to particular embodiments, workers skilled in the art will recognize that changes may be made in form and detail without departing from the spirit and the scope of the invention.

What is claimed is:

1. An apparatus for screening particulate material comprising:
an elongated frame comprising a first end and a second end;
a feed hopper attached to the first end of the elongated frame comprising a plurality of wall members operably connected to define an interior space adapted to receive particulate matter poured into a top of the feed hopper, a first stationary engagement element and a first pivotal engagement element, wherein the first stationary engagement element and the first pivotal engagement element can couple with corresponding engagement elements on the first end of the elongated frame to reversibly attach the feed hopper to the first end of the elongated frame;
a screen assembly operably coupled to the second end of the elongated frame comprising a first screen deck including a mesh portion having openings adapted to separate particulate material fed into the feed hopper; and
a conveyor operably coupled to the elongated frame and extending longitudinally along the elongated frame to convey particulate material from the feed hopper to the screen assembly.

2. The apparatus of claim 1 wherein the feed hopper further comprises a second stationary engagement element and a second pivotal engagement element.

3. The apparatus of claim 2 wherein the first and second stationary engagement elements and the first and second pivotal engagement elements each comprise a hook portion.

4. The apparatus of claim 1 wherein the screen assembly further comprises a second screen deck positioned below the first screen deck, the second screen deck including a mesh portion having openings adapted to separate particulate material fed into the feed hopper.

5. The apparatus of claim 4 wherein the mesh portion of the first screen deck has differently sized openings relative to openings of the mesh portion of the second screen deck.

6. The apparatus of claim 1 wherein the screen assembly is inclined and angles downward towards the first end of the elongated frame such that particulate material on the screen assembly travels back towards the first end of the elongated frame.

7. The apparatus of claim 1 wherein the conveyor extends uphill towards the second end and terminates at the screen assembly.

8. The apparatus of claim 1 further comprising a belt feeder positioned below the feed hopper that conveys material from the feed hopper to the first conveyor.

9. The apparatus of claim 1 further comprising a pair of endless tracks mounted to the elongated frame to facilitate movement of the apparatus.

10. The apparatus of claim 1 further comprising a first stockpiling conveyor positioned perpendicularly relative to the screen assembly such that material that is too large to pass though the first screen deck is discharged on the first stockpiling conveyor to a first side of the apparatus.

11. The apparatus of claim 4 further comprising a second stockpiling conveyor positioned perpendicularly relative to the screen assembly such that material that is too large to pass through the second screen deck is discharged on the second stockpiling conveyor to a second side of the apparatus.

12. The apparatus of claim 1 further comprising an underscreen conveyor operably coupled to, and positioned below, the screen assembly such that material that passes through the upper and lower screen decks is discharged by the underscreen conveyor.

13. The apparatus of claim 1 further comprising a fold-over hopper operably coupled to the elongated frame.

14. The apparatus of claim 1 wherein the feed hopper further comprises a plurality of hydraulic legs that can be extended and retracted to adjust the height of the feed hopper.

15. A method of operating an apparatus for screening particulate material comprising:
reversibly attaching a feed hopper to a first end of an elongated frame of a screening apparatus, wherein the screening apparatus comprises a screen assembly operably coupled to a second end of the elongated frame comprising at least one screen deck having a mesh portion adapted to separate particulate material fed into the feed hopper, and a conveyor operably coupled to the elongated frame and extending longitudinally along the elongated frame to convey particulate material from the feed hopper to the screen assembly.

16. The method of claim 15 wherein the feed hopper comprises a plurality of wall members operably connected to define an interior space adapted to receive particulate matter poured into a top of the feed hopper, at least one engagement element adapted to couple with a corresponding engagement element on the elongated frame and a plurality of hydraulic legs that can be extended and retracted to adjust the height of the feed hopper.

17. The method of claim 16 further comprising adjusting the height of the plurality of hydraulic legs to engage the engagement element with the corresponding engagement element on the elongated frame to reversibly attach the feed hopper to the elongated frame.

18. The method of claim 15 further comprising loading particulate material into the feed hopper.

19. An apparatus for screening particulate material comprising:
an elongated frame comprising a first end and a second end;
a feed hopper attached to the first end of the elongated frame comprising a plurality of wall members operably connected to define an interior space adapted to receive particulate matter poured into a top of the feed hopper and at least one engagement element that is adapted to couple with a corresponding element on the elongated frame to reversibly attach the feed hopper to the elongated frame;
a screen assembly operably coupled to the second end of the elongated frame comprising at least one screen deck having a mesh portion having openings adapted to separate particulate material fed into the feed hopper; and
a conveyor operably coupled to the elongated frame and extending longitudinally along the elongated frame to convey particulate material from the feed hopper to the screen assembly.

20. The apparatus of claim 19 wherein the engagement element comprises a hook portion and the corresponding engagement element comprises a securing tube adapted to receive the hook portion.
